(19) United States
(12) Patent Application Publication
(10) Pub. No.: US 2015/0066940 A1
(43) Pub. Date: Mar. 5, 2015

(54) PROVIDING RELEVANT ONLINE CONTENT

(71) Applicants: Roshan Fernandes, Mountain View, CA (US); Bindu Oommen Fernandes, Mountain View, CA (US)

(72) Inventors: Roshan Fernandes, Mountain View, CA (US); Bindu Oommen Fernandes, Mountain View, CA (US)

(73) Assignee: Google Inc.

(21) Appl. No.: 13/609,132

(22) Filed: Sep. 10, 2012

(51) Int. Cl. G06F 17/30

(52) U.S. Cl. 707/740; 707/748; 707/E17.046

(57) ABSTRACT

Systems and methods for providing relevant online content may include evaluating an action performed by a user identifier to determine the user's opinion regarding a topic. Content related to the topic may be selected and provided to an electronic device associated with the user identifier.

### BACKGROUND

The present disclosure relates generally to providing relevant online content.

Online content may be available regarding any number of disparate topics. For example, a first website on the Internet may be devoted to the migratory habits of bats and a second website may be devoted to automotive repair. In many cases, a user must proactively seek out online content of interest to the user. For example, an Internet user may utilize a search engine to search for webpages devoted to automotive repair. The user may then navigate between the webpages in the search results until the user finds the webpage that most closely matches the user's interests.

### SUMMARY

Implementations of the systems and methods for providing relevant online content are described herein. One implementation is a computerized method for selecting content for a user identifier. The method includes receiving, at a processing circuit, data indicative of an online action associated with the user identifier. The method also includes identifying, by the processing circuit, a topic associated with the online action. The method further includes determining, by the processing circuit, an opinion regarding the topic based on the online action. The method also includes generating, by the processing circuit, a strength score for the topic based in part on the opinion. The method yet further includes selecting content for the user identifier based in part on whether the content corresponds to the topic and further based in part on the strength score for the topic.

Another implementation is a system for selecting content for a user identifier. The system includes a processing circuit operable to receive data indicative of an online action associated with the user identifier. The processing circuit is also operable to identify a topic associated with the online action and to determine an opinion regarding the topic based on the online action. The processing circuit is further operable to generate a strength score for the topic based in part on the opinion. The processing circuit is also operable to select content for the user identifier based in part on whether the content corresponds to the topic and further based in part on the strength score for the topic.

A further implementation is a computer-readable storage medium having machine instructions stored therein, the instructions being executable by a processor to cause the processor to perform operations. The operations include receiving data indicative of text associated with a user identifier and performing text analysis on the text to identify a topic keyword and a disposition keyword in the text. The operations also include determining a weighting value based on the disposition keyword and generating a strength score for the topic based in part on the weighting value. The operations further include selecting an advertisement for the user identifier based in part on whether the advertisement corresponds to the topic and further based in part on the strength score for the topic.

These implementations are mentioned not to limit or define the scope of this disclosure, but to provide examples of implementations to aid in understanding thereof.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system in accordance with a described implementation;

FIG. 2 is an illustration of an electronic display showing an example webpage having third-party content;

FIG. 3 is an example illustration of a third-party content being included on a webpage;

FIG. 4 is an example illustration of an electronic display showing an example webpage allowing users to express their online opinions;

FIG. 5 is an example process for selecting relevant content; and

FIG. 6 is an example illustration of an expressed opinion being used to select relevant content.

Like reference numbers and designations in the various drawings indicate like elements.

### DETAILED DESCRIPTION

According to some aspects of the present disclosure, a user may opt in to receiving content that may be of interest to the user. In various implementations, a user may allow certain information about the user's online behavior to be stored and analyzed, to determine topics that may be of interest to the user. For example, history data regarding webpages visited by the user, comments or other content uploaded by a user, and other online actions may be analyzed to determine topics of interest to the user. For situations in which the systems discussed herein collect personal information about a user, or may make use of personal information, the user may be provided with an opportunity to control which programs or features collect such information, the types of information that may be collected (e.g., information about a user's social network, social actions or activities, a user's preferences, a user's current location, etc.), and/or how third-party content may be selected by a content selection service and presented to the user. Certain data, such as a user identifier, may be anonymized in one or more ways before it is stored or used, so that personally identifiable information is removed when generating parameters (e.g., demographic parameters) used by the content selection service to select third-party content. For example, a user identifier may be anonymized so that no personally identifiable information about its corresponding user can be determined from it. In another example, a user's geographic location may be generalized where location information is obtained (such as to a city, ZIP code, or state level), so that a precise location of the user cannot be determined. Thus, the user may have control over how information is collected about him or her and used by the content selection service.

In various implementations, an interest of a user may be identified by analyzing the online opinions expressed by the user about a particular topic. For example, golf may be identified as an interest of a user that favorably rates a set of golf clubs. A user may express an online opinion in any number of different ways. In one implementation, text written by a user may be analyzed to identify a user's interests. For example, an online article, blog entry, comment, or similar text from the user may be analyzed to discern the user's interests. In one implementation, a user's interactions via a social networking system may be analyzed to identify potential interests of the user, if the user so allows. In general, a social networking system refers to any computerized platform that allows a user to create a profile and associate the profile with that of other users whom the user deems as social connections. For example, a user may associate her profile with that of her friends, family, co-workers, classmates, or the like. Actions performed by the user within the social networking system may also be analyzed to identify the user's interests. For example, groups joined by the user, content recommended by the user to other users, ratings provided by the user, and similar actions may be analyzed to identify the interests of the user. In some implementations, the user may elect not to allow actions regarding certain social networking groups to be analyzed (e.g., the user may allow an opinion expressed in a public group to be analyzed, while keeping opinions expressed in other groups to remain unanalyzed for purposes of selecting content).

A website owner may participate in an advertising or other content selection network, in some implementations. Participating in an such a network may allow any number of different forms of third-party content to be presented with a webpage of the website. For example, the webpage may be modified to cause a user's device to retrieve content from a server of the content network (e.g., from a different source than that of the website). The retrieved third-party content may then be displayed as being part of the webpage or in conjunction with the display of the webpage (e.g., in another browser tab, in a pop-up window, etc.). For example, an advertisement may be retrieved and displayed when the webpage is loaded. Different third-party content may be selected by the server of the content network. For example, the webpage may display a first advertisement to a first user and a second advertisement to a second user. In this way, different advertisers can place different advertisements on a particular webpage, without the website operator having to modify the code of the webpage each time a new advertisement is to be displayed.

In some implementations, third-party content provided by a content network may be selected based on whether the third-party content is deemed to be relevant to a particular user identifier. Rather than selecting an advertisement to be provided on a webpage based on the content of the webpage itself, the selection of third-party content may take into account a user identifier. For example, a user identifier associated with visiting a website of an online retailer may be associated with an interest in knowing when the retailer is running a sale. The user identifier may then be used to select an advertisement for such a sale, regardless of the content of the webpage being visited by the user identifier. For example, assume that a user identifier is used to visit the website of an online retailer of golf clubs and then later used to visit a webpage devoted to finance. The user identifier may be associated with an interest in golf, based on the visit to the retailer's website. When the user identifier is used to later visit the financial webpage, an advertisement for a sale on golf clubs may be provided to the client device, even though the financial webpage is unrelated to golf.

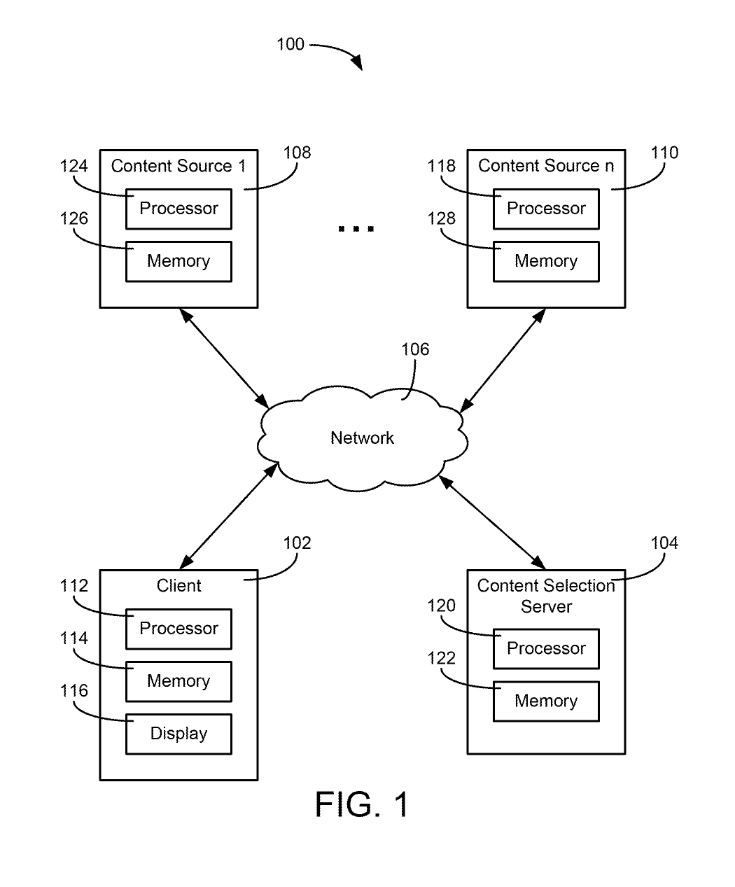

Referring to FIG. 1, a block diagram of a computer system 100 in accordance with a described implementation is shown. System 100 includes a client 102 which communicates with other computing devices via a network 106. Client 102 may execute a web browser or other application to retrieve content from other devices over network 106. For example, client 102 may communicate with any number of content sources 108, 110 (e.g., a first content source through nth content source). Content sources 108, 110 may provide webpage data and/or other content (e.g., text documents, PDF files, and other forms of electronic documents) to client 102. In some implementations, computer system 100 may also include a content selection server 104 that provides third-party content to other devices in computer system 100. For example, content source 108 may provide webpage data to client 102 that causes client 102 to retrieve an advertisement or other form of third-party content from content selection server 104. In this way, the same webpage from content source 108 may display any number of different advertisements provided by content selection server 104. In another example, client 102 may execute a non-browser application (e.g., a game, a stand-alone social networking application, etc.) that receives advertisements or other third-party content from content selection server 104.

Network 106 may be any form of computer network that relays information between client 102, content sources 108, 110, and content selection server 104. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client 102 may communicate wirelessly (e.g., via WiFi, cellular, radio, etc.) with a transceiver that is hardwired (e.g., via a fiber optic cable, a CAT5 cable, etc.) to other computing devices in network 106.

Client 102 may be of any number of different types of user electronic devices configured to communicate via network 106 (e.g., a laptop computer, a desktop computer, a tablet computer, a smartphone, a digital video recorder, a set-top box for a television, a video game console, combinations thereof, etc.). Client 102 is shown to include a processor 112 and a memory 114, i.e., a processing circuit. Memory 114 may store machine instructions that, when executed by processor 112 cause processor 112 to perform one or more of the operations described herein. Processor 112 may include a microprocessor, ASIC, FPGA, etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ROM, RAM, EEPROM, EPROM, flash memory, optical media, or any other suitable memory from which processor 112 can read instructions. The instructions may include code from any suitable computer programming language such as, but not limited to, C, C++, C#, Java, JavaScript, Perl, HTML, XML, Python and Visual Basic.

Client 102 may include one or more user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to the housing of client 102 (e.g., a built-in display, microphone, etc.) or external to the housing of client 102 (e.g., a monitor connected to client 102, a speaker connected to client 102, etc.), according to various implementations. For example, client 102 may include an electronic display 116, which displays webpages and other electronic documents received from content sources 108, 110, and/or third-party content selected by content selection server 104.

Content sources 108, 110 may be one or more electronic devices connected to network 106 that provide content to client 102. For example, content sources 108, 110 may be computer servers (e.g., FTP servers, file sharing servers, web servers, etc.) or a combination of servers (e.g., data centers, cloud computing platforms, etc.). Content may include, but is not limited to, webpage data, a text file, a spreadsheet, images, and other forms of electronic documents. Similar to client 102, content sources 108, 110 may include processing circuits having processors 124, 118 and memories 126, 128, respectively, that store program instructions executable by processors 124, 118. For example, the processing circuit of content source 108 may include instructions such as web server software, FTP serving software, and other types of software that cause content source 108 to provide content via network 106.

In some implementations, one or more of content sources 108, 110 may be part of a social networking system. For example, the user of client 104 may create a user profile on content source 110 and associate it with other user profiles belonging to the user's social connections. In such a case, content source 110 may allow users of the social networking system to upload content (e.g., images, text, video, etc.), share content with social connections, join groups devoted to certain topics (e.g., a group devoted to parasailing, a group including a user's classmates, etc.), rate content (e.g., positively rate an image uploaded by another user, etc.), or any other action associated with a social networking system. In one implementation, some or all of the functions of a social networking system may be extended to other content sources. For example, assume that content source 110 hosts a social networking website and that content source 108 hosts another website. In such a case, the website served by content source 108 may be modified to allow users of the social networking site of content source 110 to perform social networking-related actions relating to the content of content source 108 (e.g., rating the content, sharing the content with social connections, commenting on the content, etc.).

According to various implementations, content sources 108, 110 may provide commands to client 102 that cause client 102 to retrieve an advertisement or other form of third-party content from content selection server 104. For example, content sources 108, 110 may provide webpage data to client 102 that includes one or more content tags. In general, a content tag may be any piece of webpage code associated with placing an advertisement into a webpage. A content tag may define a slot on a webpage for an advertisement or other form of third-party content, a slot for an out of page advertisement (e.g., an interstitial advertisement slot), whether third-party content should be loaded asynchronously or synchronously, whether the loading of third-party content should be disabled on the webpage, whether third-party content that loaded unsuccessfully should be refreshed, the network location of a server that provides third-party content (e.g., content selection server 104), a network location (e.g., a URL) associated with clicking on an advertisement, how third-party content is to be rendered on a display, one or more advertising keywords used to retrieve an advertisement, and other functions associated with providing an advertisement or other form of third-party content on a webpage. For example, content source 108 may provide webpage data that causes client 102 to retrieve an advertisement from content selection server 104. In another implementation, the advertisement may be provided by content selection server 104 to content source 108 and provided as part of the webpage data sent to client 102. In a further implementation, client 102 may independently request third-party content from content selection server 104 or content selection server 104 may push third-party content to client 104 without first receiving such a request (e.g., as part of a game or other non-browser application).

Similar to content sources 108, 110, content selection server 104 may be one or more electronic devices connected to network 106 that select third-party content to be provided by client 102 to a user. Content selection server 104 may be computer servers (e.g., FTP servers, file sharing servers, web servers, etc.) or a combination of servers (e.g., a data center, a cloud computing platform, etc.). Content selection server 104 may include a processing circuit including a processor 120 and a memory 122 that stores program instructions executable by processor 120. For example, the processing circuit of content selection server 104 may be configured to provide an advertisement to client 102 when client 102 visits webpages served by content sources 108, 110. According to various implementations, content selection server 104 may be configured to select third-party content, such as advertisements, for client 102 based in part on potential interests of the user of client 102.

A user of client 102 may elect to allow content selection server 104 and/or content sources 108, 110 to identify and store history data relating to client 102. For example, the user may elect to allow content selection server 104 to select content that may be more relevant to him or her. In various implementations, a user identifier may be used to represent the user in system 100 and associated with the stored history data. In some implementations, a client identifier (e.g., a cookie, an IP address, a device ID, a username and/or password, etc.) may be used by content selection server 104, and/or content sources 108, 110 to identify client 102. In such a case, the user identifier may be the client identifier itself or may be associated with such a client identifier. In some implementations, a user identifier may be associated with multiple client identifiers. For example, the user of client 102 may access content sources 108, 110 and/or content selection server 104 using a number of different devices (e.g., a mobile phone, a home computer, etc.). The client identifiers for the various devices may be associated with a user identifier for the user. A user identifier and/or client identifier may also be anonymized, such that no personally-identifiable information about the user is available via analysis of the identifier.

A user identifier may be associated with one or more interest categories, based on the history data associated with the user identifier. For example, if the user identifier is associated with visiting a webpage devoted to baseball, the user identifier may be associated with the interest category of baseball. In various implementations, content selection server 104 and/or content sources 108, 110 may be configured to identify an interest category associated with a user identifier, select third-party content having a topic that matches the interest category, and/or cause the third-party content to be provided by client 102.

Various online actions associated with a user identifier may be analyzed by content selection server 104 and/or by content source 108, 110, to identify an interest category for the user identifier. For example, content selection server 104 may analyze ratings, comments, suggestions, social connections, groups, etc. to identify one or more interest categories. In other implementations, content sources 108, 110 may be configured to identify interests and provide the identified interests to content selection server 104. In further implementations, the identified interests may be limited to only the strongest interests. For example, the user of client 102 may be an avid golfer, but only mildly interested in baseball. In such a case, content selection server 104 may provide golf-related advertisements to client 102 and not provide baseball-related advertisement to client 102.

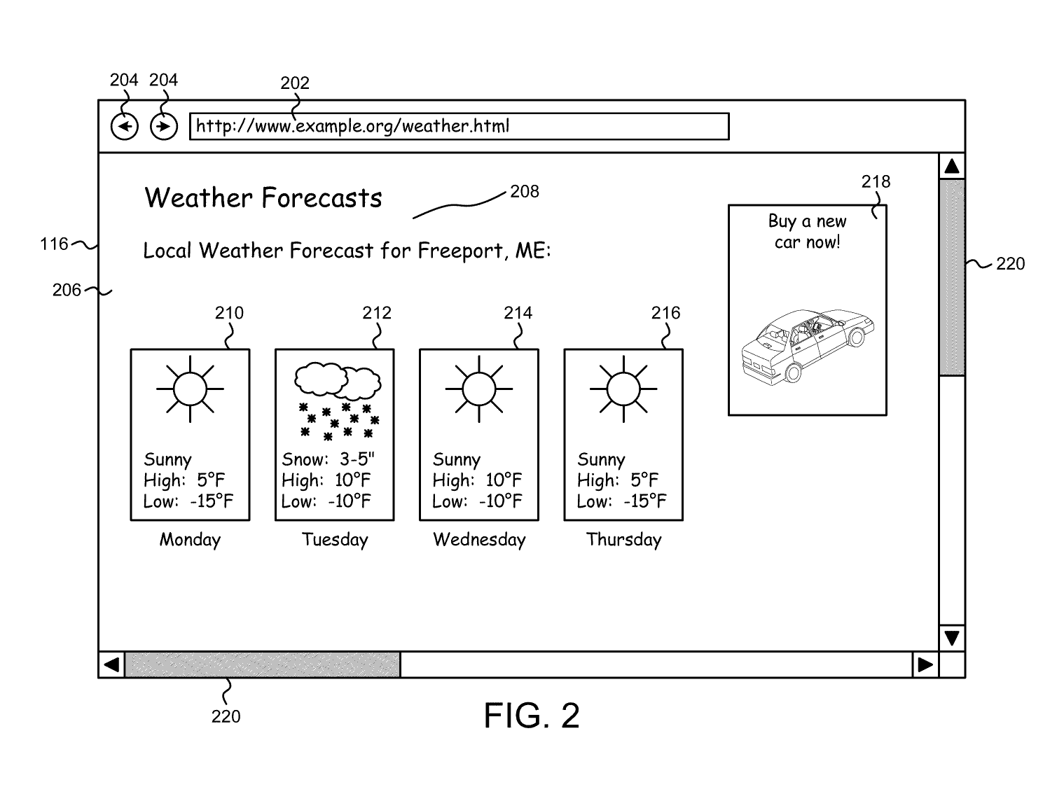

Referring now to FIG. 2, an illustration is shown of electronic display 116 displaying an example webpage 206 having an advertisement 218. Electronic display 116 is in electronic communication with processor 112 which causes visual indicia to be displayed on electronic display 116. For example, processor 112 may execute a web browser or other application stored in memory 114 of client 102 to display indicia of content received by client 102 via network 106. In various implementations, electronic display 116 may be located inside or outside of the same housing as that of processor 112 and/or memory 114. For example, electronic display 116 may be an external display, such as a computer monitor, television set, or any other stand-alone form of electronic display. In other examples, electronic display 116 may be integrated into the housing of a laptop computer, mobile device, or other form of computing device having an integrated display.

As shown, processor 112 may execute a web browser application and provide display data to electronic display 116. In one implementation, the web browser application may operate by receiving input of a uniform resource locator (URL) via a field 202 from an input device (e.g., a pointing device, a keyboard, a touchscreen, etc.). For example, the URL, http://www.example.org/weather.html, may be entered into field 202. Processor 112 may use the entered URL to request data from a content source having a network address that corresponds to the entered URL. In response to the request, the content source may return webpage data and/or other data to client 102 which may be used by client 102 to cause visual indicia to be displayed by electronic display 116.

In general, webpage data may include text, hyperlinks, layout information, and other data that may be used to provide the framework for the visual layout of displayed webpage 206. In some implementations, webpage data may be one or more files of webpage code written in a markup language, such as the hypertext markup language (HTML), extensible HTML (XHTML), extensible markup language (XML), or any other markup language. For example, the webpage data in FIG. 2 may include a file, “weather.html” provided by the website, “www.example.org.” The webpage data may include data that specifies where indicia such as text 208 appears on webpage 206. In some implementations, the webpage data may also include additional URL information used by the client device to retrieve additional indicia displayed on webpage 206. For example, the file, “weather.html,” may also include one or more instructions used by processor 112 to retrieve images 210-216 from the content source. In another example, the webpage data may include one or more content tags that cause processor 112 to retrieve one or more advertisements from an advertisement server, such as content selection server 104.

The web browser displayed on electronic display 116 may include a number of navigational controls associated with webpage 206. For example, the web browser may include the ability to go back or forward to other webpages using inputs 204 (e.g., a back button, a forward button, etc.). The web browser may also include one or more scroll bars 220, 230, which can be used to display parts of webpage 206 that are currently off-screen. For example, webpage 206 may be formatted to be larger than the screen of electronic display 116. In such a case, the one or more scroll bars 220, 230 may be used to change the vertical and/or horizontal position of webpage 206 on electronic display 116.

Webpage 206 may include text, images, or other forms of indicia to convey information to a user of client 102. For example, text 208 may indicate that webpage 206 provides information about the weather forecast for Freeport, Me. Similarly, images 210-216 may provide information about the latest weather forecast. For example, image 210 may indicate that the weather is predicted to be sunny on Monday, while image 212 may indicate that snow is predicted for Tuesday. Any combination of text, images, and/or other files may be used by webpage 206 to convey information to a user. For example, the weather forecast for Tuesday may be conveyed via text, instead of via image 212.

In one implementation, webpage 206 may include advertisement 218 which is selected by content selection server 104. For example, one or more content tags may be embedded into the webpage code located in the file “weather.html” and/or in other files of webpage 206. In other words, “weather.html” may include a content tag that specifies that an advertisement field is to be located at the position of advertisement 218. Another content tag may cause processor 112 to request an advertisement from content selection server 104, when webpage 206 is loaded. Such a request may include one or more keywords, a client identifier for client 102, or other data used by content selection server 104 to select an advertisement to provide to client 102. In this way, any number of different advertisements may be placed in the location of advertisement 218 on webpage 206. In other words, one user that requests webpage 206 may be presented with advertisement 218 and a second user that requests webpage 206 may be presented with a different advertisement.

In some implementations, advertisement 218 may be selected based in part on its relevancy to the user identifier associated with the request for webpage 206. For example, advertisement 218 may be selected using a client identifier provided to content selection server 104 when client 102 requests an advertisement. Such an identifier may be associated with one or more interest categories. In various implementations, an interest category may be indentified based in part on one or more online opinions expressed by the user of client 102. For example, assume that the user of client 102 commented on a particular brand or model of automobile, rated a particular automobile, joined a social networking group devoted to an automobile manufacturer, or expressed some other form of online opinion about an automobile or automobile manufacturer. In such a case, the expressed opinion may be used to identify the general category of automobiles, a certain type of automobile (e.g., convertibles, 4×4 trucks, etc.), a particular manufacturer of automobiles, a certain model of automobile, etc. as an interest category for the user identifier. In some implementations, advertisement 218 may be selected based on an interest category associated with a user identifier. For example, advertisement 218 may be selected by content selection server 104 to be placed on webpage 206 based on the interest category of automobiles associated with the user identifier.

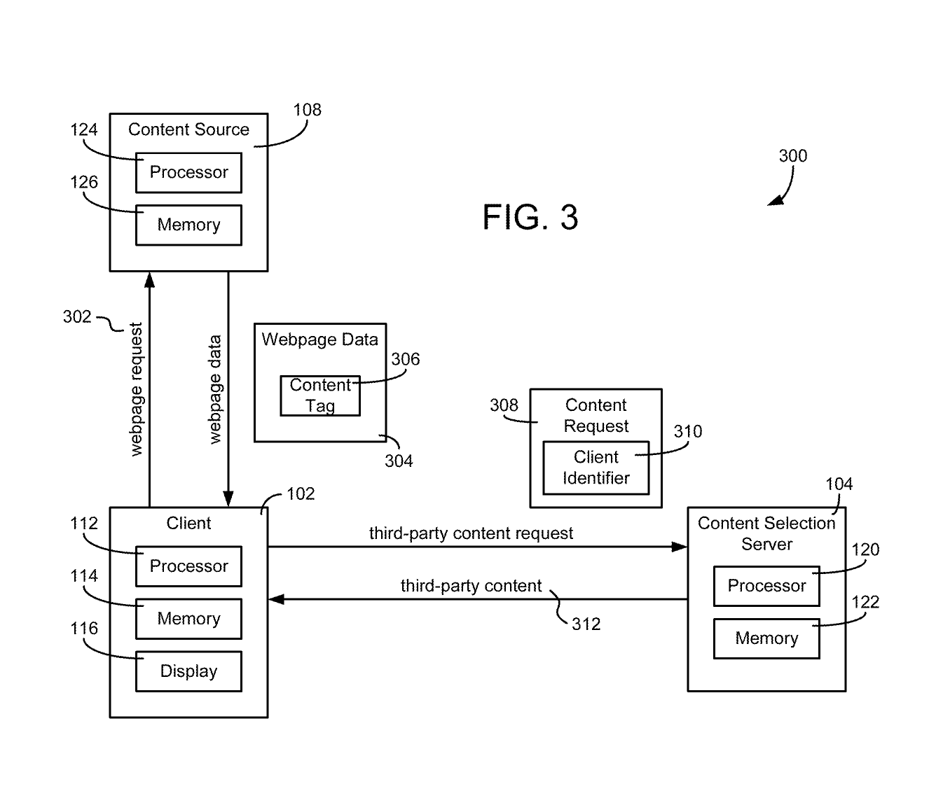

FIG. 3 is an example illustration of a third-party content 312 being selected for display with a webpage by content selection server 104. As shown, client 102 may send a webpage request 302 to a content source via network 106, such as content source 108. For example, webpage request 302 may be a request that conforms to the hypertext transfer protocol (HTTP), such as the following:

GET /weather.html HTTP/1.1
Host: www.example.org

Such a request may include the name of the file to be retrieved, weather.html, as well as the network location of the file, www.example.org. In some cases, a network location may be an IP address or may be a domain name that resolves to an IP address of content source 108. In some implementations, a client identifier, such as a cookie associated with content source 108, may be included with webpage request 302 to identify client 102 to content source 108.

In response to receiving webpage request 302, content source 108 may return webpage data 304, such as the requested file, “weather.html.” Webpage data 304 may be configured to cause client 102 to display a webpage on electronic display 116 when opened by a web browser application. In some cases, webpage data 304 may include code that causes client 102 to request additional content to be displayed with the displayed webpage. For example, webpage data 304 may include an HTML image tag of the form:

<img src=“Monday_forecast.jpg”>

Such code may cause client 102 to request the image file “Monday_forecast.jpg,” from content source 108.

In some implementations, webpage data 304 may include content tag 306 configured to cause client 102 to retrieve an advertisement or other form of third-party content from content selection server 104. In some cases, content tag 306 may be an HTML image tag that includes the network location of content selection server 104. In other cases, content tag 306 may be implemented using a client-side scripting language, such as JavaScript. For example, content tag 306 may be of the form:

<script type= ‘text/javascript’>
AdNetwork_RetrieveAd(“argument”)
</script>

where AdNetwork_RetrieveAd is a script function that causes client 102 to send a third-party content request 308 to content selection server 104. In some cases, the argument of the script function may include the network address of content selection server 104, the referring webpage, and/or additional information that may be used by content selection server 104 to select an advertisement to be included on the webpage.

Third-party content request 308 may include a client identifier 310, used by content selection server 104 to identify client 102. In various implementations, client identifier 310 may be an HTTP cookie previously set by content selection server 104 on client 102, the IP address of client 102, a unique device identifier for client 102, login credentials, other forms of identification information, or combinations thereof. For example, content selection server 104 may set a cookie that includes a unique string of characters on client 102 when an advertisement is first returned to client 102 by content selection server 104. Such a cookie may be included in subsequent advertisement requests send to content selection server 104 by client 102. Client identifier 310 may be associated with a user identifier or may be used by content selection server 104 as a user identifier, according to various implementations.

In response to receiving third-party content request 308, content selection server 104 may select third-party content 312 to be returned to client 102 and displayed with the webpage requested from content source 108. Content selection server 104 may select third-party content 312 based on client identifier 310, in some implementations. In some implementations, content selection server 104 may use client identifier 310 to identify an interest category for a user identifier. In various implementations, content selection server 104 may be configured to run an advertisement auction in which advertisers compete to provide an advertisement on the requested webpage. For example, if travel is an identified interest category for the user identifier, an advertiser that sells airline tickets may bid in such an auction to advertise to the user identifier. In response to receiving third-party content 312, client 102 may display third-party content 312 with the retrieved webpage on electronic display 116. In other implementations, content selection server 104 may instead select third-party content already stored on client 102 and provide an indication of the selection to client 102. In response, client 102 may retrieve the pre-stored third-party content from memory 114 and display the advertisement with the displayed webpage.

In some implementations, content selection server 104 may be configured to identify one or more interest categories based in part on online opinions associated with a user identifier. In general, an online opinion refers to any online indication of a user's disposition towards a certain topic or set of topics. For example, a user may positively rate an article devoted to Judo or share the article with one or more of his friends. These actions may be treated as the user expressing a positive opinion about the sport of Judo. In another example, the user may express an opinion textually (e.g., via a public status feed, online article, comment, instant message, or the like). In such a case, the text may be analyzed to identify one or more topics and the user's disposition towards the topics. In other implementations, some or all of the interests may be identified by another entity and provided to content selection server 104. For example, a social networking system may identify one or more interest categories for a user identifier and provide data regarding these interest categories to content selection server 104. Such identified interests may then be used by content selection server 104 to select relevant third-party content for client 102.

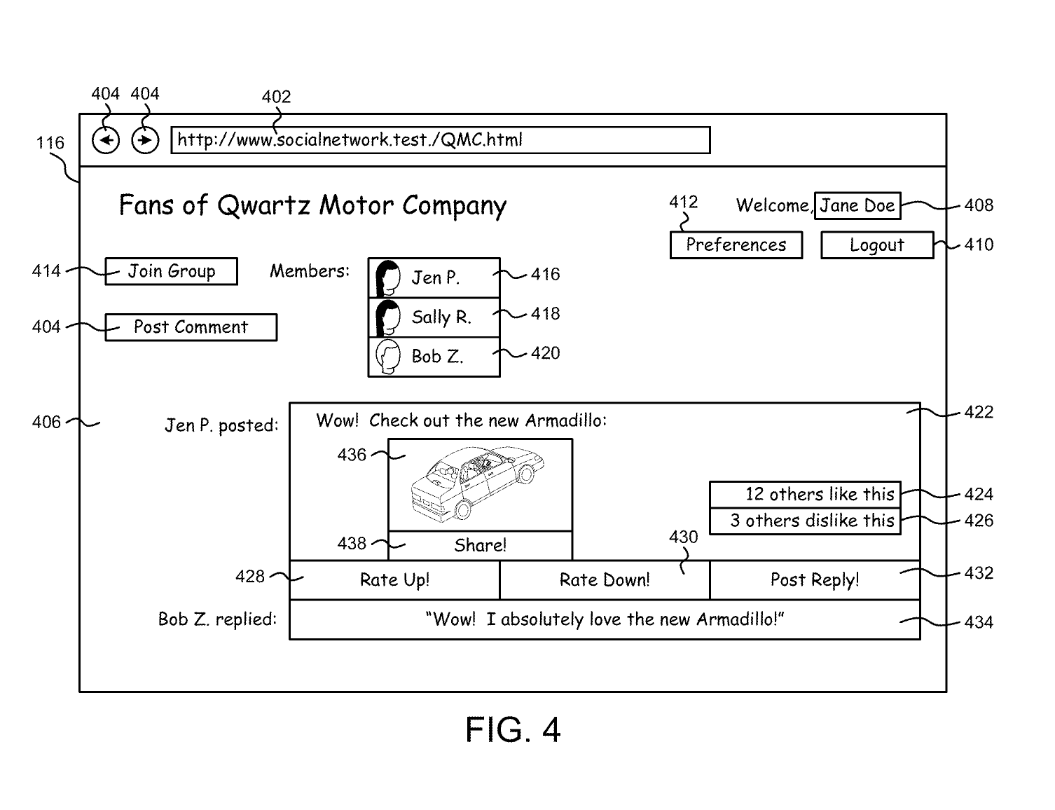

Referring now to FIG. 4, an illustration 400 is shown of electronic display 116 displaying example webpage 406. As shown, the web browser application shown in FIG. 2 or another application may receive webpage data located at the URL, http://www.socialnetwork.test/QMC.html, and use the webpage data to display webpage 406. In some implementations, webpage 406 may be part of a social networking website. For example, webpage 406 may be a social networking group devoted to the Quartz Motor Company. In other implementations, some or all of the functions described with regard to webpage 406 may be provided within another stand-alone application (e.g., a social networking application for a mobile device, an email program, etc.) and/or by a webpage that incorporates social networking functions (e.g., a fan page that allows users to rate content on the webpage, a webpage that includes a function that allows users to recommend the webpage to others, etc.).

Webpage 406 may be configured to receive input from a user interface device. In response, the application displaying webpage 406 may cause client 102 to transmit data to a remote device via network 106. For example, client 102 may transmit data to the content source that provides webpage 406 (e.g., content source 108 or 110) and/or to another server located on network 106. In some implementations, input received via webpage 406 may be stored locally (e.g., in memory 114 of client 102).

Webpage 406 may be configured to allow a user to interact with his or her user profile of a social networking system. For example, assume that the user of client 102 has logged into their social networking profile. In such a case, webpage 406 may include an identifier 408 that conveys that the user, “Jane Doe,” has logged into her profile. Webpage 406 may also include other profile-related inputs. For example, webpage 406 may include a preferences input 412 configured to receive preferences associated with the user's profile. Example preferences include the display size, shape, color, font, etc., of webpage 406, demographics and/or other personally-identifiable information about the user, security preferences relating to how information about the user is shared with others, and other similar preferences. In some cases, webpage 406 may include a logout input 412, configured to allow the user to log out of their social networking profile.

In one implementation, webpage 406 may include an input 414 configured to allow the user of client 102 to join the social networking group. For example, selection of input 414 by a user logged into his or her social networking profile may cause a join request to be transmitted to a server of the social networking system. In response to receiving such a request, the server may associate the profile of the user of client 102 with that of the social networking group and/or other members of the group. For example, users 416, 418, 420 may be members of the social networking group. In some implementations, joining the social networking group may allow a user to interact with the social networking group (e.g., by uploading content to the group, posting a comment, etc.). In some cases, an indication of the actions of a member of the group may be sent to other members. For example, a member of the social networking group may receive a status update, email message, etc. when another member interacts with the social networking group.

Webpage 406 may include an input 404 configured to allow a user to post a comment to webpage 406. Comments may include text, a hyperlink, and/or an uploaded or linked file (e.g., an image file, a video file, etc.). For example, user 416 may post a comment 422 devoted to the newest model of automobile from Quartz Motor Company, the Armadillo. Comment 422 may include an image 436 of the Armadillo, in one example. Input 404 may be available to all users, users that are members of the social networking group, or only those members authorized by an administrator of the social networking group to post comments, according to various implementations. Webpage 406 may include some or all of the comments posted to the social networking group. In some implementations, a comment entered via webpage 406 may be displayed as part of another webpage (e.g., a profile webpage for user 416 or the like). In further implementations, webpage 406 may include input 432 configured to allow a user to reply to a posted comment. For example, user 420 may post a reply 434 to comment 422.

In various implementations, a user may rate content on webpage 406. Example content on webpage 406 that may be rated include comments, images, videos, webpage 406 itself, etc. For example, a user may positively rate comment 422 via rating input 428, negatively rate comment 422 via rating input 430, post a reply to comment 422 via input 432, or perform other actions. Ratings may be on a binary scale or a sliding scale (e.g., on a scale from one to ten, on a scale of A-F, etc.). Ratings may also be positive and/or negative. In some implementations, webpage 406 may include indication 424 and/or indication 426 configured to provide an aggregated count of positive and negative ratings, respectively. For example, indications 424, 426 may provide counts of the number of users that positively or negatively rated comment 422, an average positive or negative rating for comment 422, an aggregate positive or negative score for comment 422, or the like.

Users of webpage 406 may share content on webpage 406 and/or the webpage itself with other users. For example, webpage 406 may include an input 438 configured to allow a user to share image 436 with other users. In other words, input 438 may be used to recommend content to another user, such as a social connection. In one implementation, input 438 may be configured to cause image 436 or other recommended content to be sent to another user. For example, selection of input 438 may cause image 436 to be sent to one or more selected users, certain social connections of the user, or all social connections of the user. In another implementation, selection of input 438 may cause a link to image 436 or to webpage 406 to be sent to one or more other users. In this way, a user may recommend online content to other users.

In various implementations, user actions regarding webpage 406 may be associated with a user identifier and analyzed to determine an opinion regarding one or more topics. Actions that may be analyzed may include, but are not limited to, joining the social networking group of webpage 406, rating content on webpage 406, sharing content from webpage 406 with other users, providing content to webpage 406 (e.g., by uploading an image or other file, entering a comment, etc.), or other actions associated with a social networking system. For example, a user identifier may be associated with an interest category relating to automobiles, products from the Quartz Motor Company, and/or a particular product, such as the Armadillo, based on comment 422 being positively rated. In some implementations, the strength of an opinion may also be assessed. For example, a user that positively rates a comment about the Armadillo may not feel as strongly about the product than if the user shared image 436 with a friend. In various implementations, text analysis or image recognition may be employed to identify topics of webpage 406 on which a user opined. For example, image recognition may be used on image 436 to identify that the image is of an automobile.

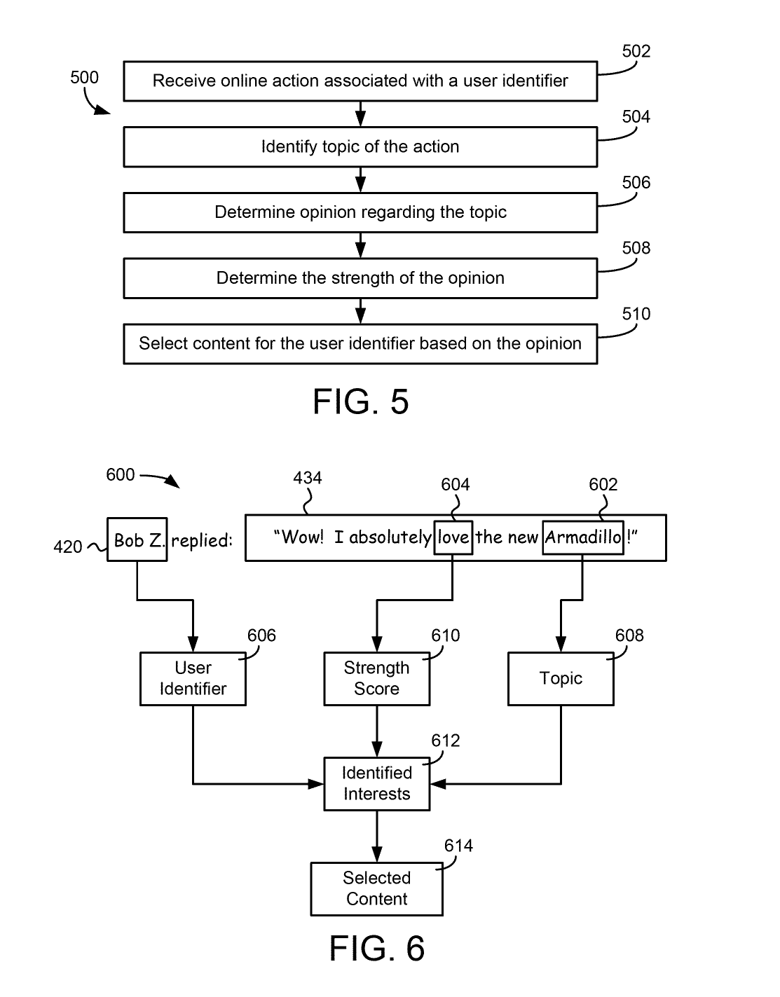

Referring now to FIG. 5, an example process 500 for selecting relevant content is shown. In general, process 500 enables relevant content to be selected, based on one or more online opinions associated with a user identifier. Process 500 may be implemented by any number of computing devices. For example, process 500 may be implemented by a content selection server, such as content selection server 104 shown in FIG. 1. In another example, process 500 may be implemented by a content selection server working in conjunction with one or more content sources (e.g., a social networking server, another web server, etc.).

Process 500 may include receiving an indication of an online action associated with a user identifier (block 502). In general, an online action refers to any action performed by a user operating a client device that causes data to be transmitted from the device to one or more servers via a network. Example actions include sending text (e.g., an online article, a comment, an email, an instant message, etc.), uploading a file (e.g., an image, video, etc.) to the server, rating online content, sharing online content, and joining a social networking group. An indication of such actions may include, but is not limited to, input data received via a user interface device corresponding to a request to perform the action, data associated with performing the action (e.g., text data corresponding to an online comment, an image to be shared with a social connection, etc.), confirmation data that the action has been performed, or the like.

Process 500 may include identifying one or more topics associated with the action (block 504). A topic may be a single category or may be part of a hierarchy of topics. For example, the topic of baseball may be a stand-alone topic category or may be part of a hierarchy of topics, such as Entertainment>Sports>Baseball, where baseball is a sub-category of the topic of sports. In some implementations, text analysis and/or image recognition may be used to determine a topic associated with the online action. In one example, text analysis may be used to determine a topic within the text of a webpage visited by the user identifier or within entered text (e.g., within an instant message, comment, email, uploaded text document, etc.). In one implementation, a statistical measure of the frequency of a term within a body of text may be used to determine a topic of the text. For example, a term frequency-inverse document frequency (TF-IDF) score may be assigned to words within a body of text and used to determine whether the text pertains to a certain topic. In one implementation, image recognition may be used to identify a topic of a digital image (e.g., an image on a webpage visited by the user identifier, an image shared with a social connection, an uploaded image, etc.). For example, an uploaded image of an automobile may be analyzed using image recognition to identify the topic of automobiles. In some cases, the image recognition may employ facial recognition. For example, an image of a famous baseball player may be analyzed to determine that the image relates to the topic of baseball. In further implementations, a topic may be self-reported by a webpage. For example, a topic of a webpage may be explicitly identified within a meta tag of a webpage, identified as part of an advertisement request, or using a similar mechanism.

Process 500 may include determining an opinion regarding an identified topic (block 506). In general, an opinion regarding a topic may be positive or negative. In some cases, the opinion regarding a topic may be determined based solely on the type of online action. For example, joining a social networking group, rating up online content, or sharing online content may correspond with a positive opinion of a topic. In another example, leaving a social networking group or rating down online content may correspond with a negative opinion of a topic. In some implementations, text analysis may be used to identify one or more disposition words within text (e.g., within the text of a webpage, within text entered by the user, etc.). For example, the words “like,” “love,” “hate,” “dislike,” etc. may be identified within the text to determine an opinion regarding the topic. In some cases, the opinion may be determined using both identified text words and the online action. For example, a user may join a social networking group devoted to protesting a certain corporation. In such a case, text associated with the group may be analyzed to determine that the user has a positive opinion of the networking group itself, but a negative opinion of the corporation. In further implementations, a textual opinion posted without the user logging into a profile may also be analyzed. For example, a user may post an online comment without logging into a profile. In such a case, the comment may still be associated with a user identifier, such as a cookie, and analyzed to determine an opinion.

Process 500 may include determining the strength of an opinion (block 508). In various implementations, the strength of how positively or negatively a user views a topic may be determined. For example, a user may be weakly interested in baseball and strongly interested in bowling. In one implementation, the strength of an opinion regarding a topic may be determined based on the type of online action from which the opinion is determined. A weighting may be applied to different action types to denote the strength of the opinion. For example, the following weights may be applied to different types of actions:

w_{sharing}>w_{commenting}>w_{joining}>w_{rating}

where w_{sharing} is a weight for sharing content with another user, w_{commenting} is a weight for commenting on a topic, w_{joining} is a weight for joining a social networking group devoted to a topic, and w_{rating} is a weight for rating content associated with a topic. In other words, a user that feels strongly about a particular topic may share content related to the topic with other users, such as the user's social connections. A user that only positively rates content related to the topic, however, may have only a weak opinion regarding the topic. In some implementations, action weights may have positive or negative values, based on whether the user has a positive or negative opinion regarding the topic. Action weights may also be ordered in any number of different ways and may include weights for any number of different types of actions.

In cases in which text analysis is used, different word weights may be applied to potential words within the text. For example, words such as “love” or “hate” regarding a particular topic may receive higher weights than that of the words “like” or “dislike.” In some implementations, an action weight may be combined a word weight to produce an overall weight for the opinion. In one example, assume that a user posts a comment about a topic that includes the word “love.” In such a case, an action weight, w_{commenting} may be adjusted upward. In another example, assume that the user joins a social networking group named, “People that hate the new Armadillo.” Since the word “hate” is used, an action weight, w_{joining} may be adjusted to be even more negative regarding the topic of the group.

In some implementations, an overall opinion may be determined by analyzing any number of different online actions regarding a particular topic. Such a strength score may be determined by aggregating the various action and/or word weights regarding the topic. For example, a strength score (S_{topic}) may be determined by analyzing n number of actions regarding the topic as follows:

$${S}_{topic} = {\sum }_{i = 1}^{n} {weight}_{action} ( i )$$

where weight_{action}(i) is the action weight for the ith online action performed regarding the topic. For example, a user may post ten comments regarding a topic, join two social networking groups regarding the topic, and share an article about the topic with a social connection. In such a case, different actions may be analyzed to determine a strength score for the user's opining regarding the topic.

Process 500 may include selecting content for the user identifier based on the opinion (block 510). In one implementation, an advertisement may be selected based on a user identifier being associated with a positive opinion of a topic. For example, an opinion of golf may be determined to be highly positive. In such a case, an advertisement from an online retailer of golf equipment may be selected to be provided to the user identifier (e.g., in response to receiving a third-party content request or the like). Such an advertisement may be provided as part of a webpage devoted to the topic or may be provided as part of an unrelated webpage. For example, assume that the user identifier is associated with a strongly positive opinion of golf and later associated with a visit to a webpage related to the latest weather forecast. In such a case, a golf-related advertisement may be selected to be displayed in conjunction with the weather-related webpage. In further implementations, an identified opinion may be used to select or recommend other forms of content to the user identifier. For example, the latest scores for a golf tournament may be provided automatically (e.g., without further user action) to a user identifier associated with a strong interest in golf.

Referring now to FIG. 6, an example illustration 600 of an expressed opinion being used to select relevant content is shown. In the example shown, comment 434 posted by user 420 to webpage 406 in FIG. 4 may be analyzed to determine an opinion of the user regarding a particular topic. If the user's opining is favorable to the topic, the user's opinion may then be used to generate a set of one or more topics that may be of interest to the user. Content, such as an advertisement 614, may also be selected based on an identified interest of user 420.

In one implementation, user 420 may be associated with a user identifier 606. User identifier 606 may be any form of unique data usable by the system to represent user 420. User identifier 606 may be, for example, a client identifier, a unique identifier associated with one or more client identifiers, and/or login data for a social networking service. For example, user identifier 606 may include a screen name/password for user 420, one or more client identifiers for devices operated by user 420, biometric data for user 420, or similar data usable to attribute a particular online action to a specific user identifier. When user 420 performs an online action, the action may include such identification information to associate the action with user identifier 606. For example, user 420 may be represented in the system by user identifier 606 and may post comment 434. Comment 434 may then be associated by the system with user identifier 606.

Comment 434 may be textually analyzed to determine one or more topics present within the text. For example, the text of comment 434 may be parsed by a server to identify various keywords in the text. Such keywords may be matched to defined topical categories, to determine that comment 434 relates to a particular topic. For example, the text of comment 434 may be analyzed to identify keyword 602, “Armadillo,” a particular model of automobile. Keyword 602 may be itself by a topic of interest or may be mapped to a topic 608. For example, “Armadillo” may itself be an identified topic or may be mapped to the topic category of Vehicles>Automobile. In some implementations, keyword 602 may be used to identify a number of topic categories within a hierarchy. For example, topic 608 may be the top category of “Vehicles,” the sub-category of “Automobiles,” or a combination of topics along a hierarchy.

A strength score 610 may be determined for topic 608 based on the type of performed action (e.g., posting comment 434) and/or based on the strength of the language within comment 434. For example, strength score 610 may be determined based on a weighting value associated with the action of posting a comment. In some implementations, such a weighting value may also based on the words within comment 434. Similar to the identification of topical keyword 602 using text analysis, a disposition keyword 604 may be identified in comment 434. Keyword 604 may be used to determine the user's opinion regarding topic 608 and/or the strength of the opinion. For example, the word “love” may indicate that the user has a strongly positive opinion of topic 608. In such a case, a weighting value corresponding to a user posting a strongly positive comment about topic 608 may be used to determine strength score 610 or may itself be used as strength score 610. In some implementations, strength score 610 may be based on any number of actions regarding topic 608 (e.g., joining a social networking group related to topic 608, rating up content related to topic 608, etc.).

In one implementation, one or more identified interests 612 may be determined for user identifier 606. Identified interests 612 may include, for example, topics in which user 420 views positively. Online actions associated with user identifier 606 may be analyzed to identify any number of topics and to determine strength scores for those topics. For example, strength score 610 may indicate that user 420 views topic 608 highly favorably. In such a case, topic 608 may be included in identified interests 612. In some implementations, a limit may be imposed on the number of topics included in identified interests 612. Therefore, which topics are included in identified interests 612 may also be based on their corresponding strength scores. In other words, only the topics in which user 420 views most favorably may be included in identified interests 612. For example, identified interests 612 may include the top five or fewer topics that user 420 views most favorably.

Identified interests 612 may be used to select advertisement 614, according to various implementations. For example, a content request from a client device operated by user 420 may be sent to a content selection server. Such a request may include a client identifier or other form of data used by the server to determine that the request is associated with user identifier 606. In such a case, the content selection server may select content 614 based in part on whether the content is related to a topic in identified interests 612. In some implementations, the content selection server may conduct an advertisement auction in which different advertisers compete to provide relevant advertisements to user 420. In such a case, the advertisers may specify which user interest categories in which they wish to bid. For example, an online retailer of golf equipment may opt to bid in advertisement auctions involving user identifiers associated with an interest category of golf. In further implementations, the content selection server may select content 614 based on identified interests 612 and without first receiving a content request (i.e., the content selection server may “push” content 614 to a client device associated with user identifier 606).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

1. A computerized method for selecting content for a user identifier comprising:
receiving, at a processing circuit, data indicative of an online action associated with the user identifier;
identifying, by the processing circuit, first content to which the online action corresponds;
identifying, by the processing circuit, a topic associated with the first content to which the online action corresponds;
identifying, by the processing circuit, for the online action associated with the user identifier, a type of a plurality of types of online action;
determining, by the processing circuit, an opinion regarding the topic based on the online action;
determining, by the processing circuit, an action weight of the opinion based on the identified type of online action;
generating, by the processing circuit, a strength score for the topic based in part on the determined action weight of the opinion;
receiving, at the processing circuit, a content request from a client device associated with the user identifier;
retrieving, from a memory, a plurality of interest categories including the topic associated with the user identifier based on the received content request;
selecting, for the user identifier responsive to the content request, a second content associated with the topic of the first content based on the topic of the first content and the strength score for the topic; and
providing, for display, the second content to the client device.

2. The method of claim 1, wherein the online action corresponds to entering text regarding the topic.

3. The method of claim 1, wherein the online action corresponds to joining a social networking group related to the topic.

4. The method of claim 1, wherein the online action corresponds to recommending online content related to the topic with a social connection.

5. The method of claim 2, further comprising:
performing text analysis on the text to identify the topic and the opinion regarding the topic within the text.

6. The method of claim 5, further comprising:
identifying a disposition word within the text;
determining a weighting value based on the online action and the disposition word; and
using the weighting value to determine the strength score for the topic.

7. The method of claim 6, wherein the disposition keyword comprises one of the words like, love, dislike, hate, fancy, favor, disfavor, relish, affirm, trust, abhor, or rue.

8. (canceled)

9. (canceled)

10. A system for selecting content for a user identifier comprising:
one or more processors; and
a memory, the memory having processor executable instructions stored thereon, which when executed by the one or more processors, cause the one or more processors to perform operations comprising:
receive data indicative of an online action associated with the user identifier;
identify a topic related to content with which the online action is associated;
determine an opinion regarding the topic based on the online action;
determine an action weight of the opinion based on a type of online action;
generate a strength score for the topic based in part on the determined action weight of the opinion;
receive a content request from a client device associated with the user identifier;
retrieve, from the memory, a plurality of interest categories including the topic associated with the user identifier based on the received content request;
select, for the user identifier responsive to the content request, a second content associated with the topic of the first content based on the topic of the first content and the strength score for the topic; and
provide, for display, the second content to the client device.

11. The system of claim 10, wherein the online action corresponds to entering text regarding the topic.

12. The system of claim 10, wherein the online action corresponds to joining a social networking group related to the topic.

13. The system of claim 10, wherein the online action corresponds to recommending online content related to the topic with a social connection.

14. The system of claim 11, wherein the processor is further configured to perform text analysis on the text to identify the topic and the opinion regarding the topic within the text.

15. The system of claim 14, wherein the processor is further configured to:
identify a disposition word within the text;
determine a weighting value based on the online action and the disposition word; and
use the weighting value to determine the strength score for the topic.

16. (canceled)

17. (canceled)

18. A computer-readable storage medium having instructions stored therein, the instructions being executable by a processor to cause the processor to perform operations comprising:
receiving data indicative of text associated with a user identifier;
performing text analysis on the text to identify a topic keyword and a disposition keyword in the text;
determining a weighting value based on the disposition keyword;
generating a strength score for the topic based on the weighting value;
receiving a content request from a client device associated with the user identifier;
retrieving, from a memory, a plurality of interest categories including the topic associated with the user identifier based on the received content request;
selecting an advertisement for the user identifier based on the topic and further based on the strength score for the topic; and
providing, for display, the advertisement to the client device.

19. The computer-readable storage medium of claim 18, wherein the processing circuit is further operable to perform text analysis on the text to identify the topic and the opinion regarding the topic within the text.

20. The computer-readable storage medium of claim 19, wherein the operations further comprise:
identifying a disposition word within the text;
determining a weighting value based on the online action and the disposition word; and
using the weighting value to determine the strength score for the topic.
